(19) United States
(12) Patent Application Publication
(10) Pub. No.: US 2026/0056921 A1
(43) Pub. Date: Feb. 26, 2026

(54) Transformation Logic and Mapping Database for Computing Profile Properties and Filtering Entity Data

(71) Applicant: Klaviyo, Inc., Boston, MA (US)

(72) Inventors: Nicholas Hartmann, Boston, MA (US); Isabel Yap, Boston, MA (US); Anna Khomenko, Boston, MA (US); Tricia Gregg, Boston, MA (US); Jacob Brandt, Boston, MA (US); Thomas Dinitz, Pasadena, CA (US)

(21) Appl. No.: 19/298,462

(22) Filed: Aug. 13, 2025

Related U.S. Application Data
(60) Provisional application No. 63/685,597, filed on Aug. 21, 2024.

(51) Int. Cl. G06F 16/21

(52) U.S. Cl. CPC G06F 16/211

(57) ABSTRACT

A system for computing and storing a profile property to an entity profile database for multiple entities comprises a recency frequency monetary value (RFM) server platform. The RFM server platform comprises a raw score module for computing a raw score for each of recency, frequency, and monetary value for each of the entities based on the profile data; a transformation engine transforms the computed recency, frequency and monetary raw scores to a multi-dimensional vector for each entity; a mapping database maps the vector to an RFM cohort; and a main module receives the entity data from the entity profile database, communicates with the transformation engine and mapping database, and stores the RFM cohort as a property for each of the entities to the entity profile database. Filtered entity groups and automating content and delivery of electronic messaging can be performed based on the assigned cohorts. Related methods are also described.

### CROSS REFERENCE TO RELATED APPLICATION

This claims priority to application No. 63/685,597, filed Aug. 21, 2024, and entitled “Storing User-Defined Query Logic in a Database for Filtering Entity Data”, the entirety of which is herein incorporated by reference.

### FIELD OF THE DESCRIBED EMBODIMENTS

The described embodiments relate generally to data processing and management. More particularly, the described embodiments relate to transformation logic and a mapping database for computing profile properties, filtering entity data, and performing electronic message automations.

### BACKGROUND

Data segmentation is the process of taking data and dividing it up and grouping similar data together based on chosen parameters. For example, a shoe company might segment its database to show which customers purchase tennis shoes the most versus which customers purchase dress shoes. An office supply store might segment its business buyers into categories such as “furniture buyers,” “paper buyers” and “printer ink buyers.”

Recency frequency monetary value (RFM) analysis is a technique used to group customers into different cohorts according to their spending habits. The cohorts are defined by three dimensions: Recency—how recently did a customer place their latest order; Frequency—how many total orders has the customer placed; and Monetary Value—how much money has the customer spent.

Describing an individual customer by these three dimensions gives a well-rounded snapshot of the customer, and allows one to define customer groups that would be better served by different types of communication. A different strategy for communicating can be generated for each type of computed cohorts.

Although RFM analysis has been used to various degrees in the past, there is no standard way to compute the cohorts of customers, much less an automated tool to allow a user to customize cohorts, filter entities and perform electronic message automations based on the mapped cohorts, as described herein.

Accordingly, it is desirable to have improved methods, apparatuses, and systems for storing user-defined query logic including customizable RFM cohorts in a database for filtering entity data.

### SUMMARY

In embodiments, a computer-implemented method for computing and storing a profile property to an entity profile database for multiple entities comprises the steps of receiving profile data of multiple sub-users or entities, computing a raw score for each of recency, frequency, and monetary value for each of the entities; transforming the raw scores to a single multi-dimensional vector for each entity based on a transformation model; mapping each vector to one of a plurality of types RFM cohorts or categories; and assigning and storing the RFM cohort as a data point or property for each of the sub-users or entities.

In embodiments, for each sub-user or entity, the previously computed RFM cohort is also stored as a datapoint or profile property. For embodiments, if a sub-user use to be a first type of RFM cohort (e.g., a ‘champion’) and is now a second type of RFM cohort (e.g., a ‘Loyalist’), both the previous and instant RFM data points are stored for each sub-user profile. Users can create logic rules to apply RFM cohort transition information such as “send an electronic message to all sub-users who used to be Champions and are now Loyalists”.

In embodiments, prior to the storing step, the computer-implemented method further comprises previewing the RFM cohort assignments as candidate RFM cohorts to the user.

In embodiments, after the previewing step but prior to the storing step, the computer-implemented method further comprises: accepting adjustments to the transformation model from the user; recomputing the vectors for each of the entities; re-mapping the vectors to the RFM cohorts for each of the entities; and re-previewing the RFM cohorts as candidate RFM cohorts to the user. The process is repeated until the user accepts the candidate RFM cohorts which are then stored as confirmed RFM cohorts, and typically, assigned to each sub-user/entity as a data point or profile property.

In embodiments, the computer-implemented method comprises generating a first list of sub-user profiles from a database of stored sub-user or entity data based on filtering the sub-user or entity data by a first RFM cohort; and optionally, sending an electronic message to each of the sub-users in the first list corresponding to the first RFM cohort.

In embodiments, the method tracks a sub-user's current RFM cohort, its most recent different RFM cohort, and the date on which it most recently switched RFM cohorts. For embodiments, if a sub-user transitioned from a first cohort (e.g., ‘Champion’) to a second cohort (e.g., ‘Needs Attention’) on Jul. 1, 2024, this transition information is stored for the sub-user's profile. The user can then modify the audience or electronic message(s) according to any of the cohort transition information (e.g., an email can be sent to all the sub-users that transitioned from ‘Champion’ to ‘Needs Attention’ within the last month).

In embodiments, the computer-implemented method comprises generating an electronic message and modifying the content of the message or another property of the electronic message based on the type of RFM property of the sub-users and optionally, sending the modified electronic message to each of the sub-users.

In embodiments, the computer-implemented method comprises monitoring sub-user behavior or activity for a trigger event, evaluating the computed RFM data point of the sub-user responsible for the triggering event, and providing a type of candidate electronic action for the user to perform based on the RFM data point of the sub-user responsible for the trigger event.

Another embodiment of the invention includes a system for computing and storing a profile property to an entity profile database and for filtering the entities. The system comprises: a backend server; a database, wherein entities are stored in the database; and a user server electronically connected to the backend server. The backend server is configured to: receive profile data of multiple entities; compute a raw score for each of recency, frequency, and monetary value for each of the entities; transform the raw scores to a vector for each entity based on a transformation model; map each vector to one of a plurality of types RFM cohorts or categories; and store the RFM cohort as a data point or property for each of the entities.

Another embodiment is a system or method comprising computing an RFM value; assigning it as a sub-user data point, and optionally, providing one more electronic actions to the user based on the RFM value.

Another embodiment comprises a non-transitory machine-readable medium, comprising executable instructions that, when executed by a processing system including a processor, perform operations for computing a sub-user profile property, the operations comprising: receiving profile data of multiple sub-user or entities; computing a raw score for each of recency, frequency, and monetary value for each of the entities; transforming the raw scores to a vector for each entity based on a transformation model; mapping the vector to a plurality of types RFM cohorts or categories; and assigning and storing the RFM cohort as a data point or property for each of the sub-user or entities.

In embodiments, the mapping is automatically performed, on a processor, and using a lookup table.

In embodiments, for each sub-user or entity, a previously computed RFM cohort is also stored as a datapoint or profile property, and optionally, a logic rule is applied based on an RFM cohort transition/change to compute an audience or electronic message content to send.

In another embodiment, a system for computing and storing a profile property to an entity profile database for multiple entities comprises: an entity profile database for collecting and storing profile data for multiple entities; and an RFM server platform.

In embodiments, the RFM server platform comprises: a raw score module for computing a raw score for each of recency, frequency, and monetary value for each of the entities based on the profile data of the entities; a transformation engine comprising logic for transforming the computed recency, frequency and monetary raw scores to a single multi-dimensional vector for each entity; a mapping database for creating and storing data tables comprising a mapping matrix for mapping the vector to an RFM cohort; and a main module for receiving the entity data from the entity profile database, communicating with the transformation engine and mapping database, and assigning and storing the RFM cohort as a property for each of the entities to the entity profile database.

In embodiments, filtered entity groups, namely, segments, as well as automating content and delivery of electronic messaging can be based on the assigned cohorts.

### Objects and Advantages

Embodiments of the invention described herein provide a number of advantages including but not limited to:

To increase speed by implementing the translation function separately from (and differently than) cohort mapping. The inventors recognize that organizing the translation and mapping functions into separate phases and modules optimizes the speed and flexibility because (a) the programmed translation engine is best for running an algorithm on the raw scores where the user may desire changes and modification to affect ranking and fine tuning; and (b) the database and tables are more well suited for selecting/matching a cohort based on the multidimensional vector where the number of sub-users can be several million.

To increase speed by, in embodiments, limiting the mapping operation to the RFM database where the cohort value is looked up by matching the subject vector to a vector in a row in the table.

To increase flexibility by designing a system in which the user can execute, preview, and modify the translated scores by adjusting the parameters to the translation model without impacting the predefined mapping matrix stored in the database.

To automatically group profiles into “RFM cohorts”—groups with different spending habits, so that merchants have a way to distinguish between different types of buyers that require different types of communication;

To provide an analytics dashboard that shows the number of profiles in each cohort, as well as the number of profiles who have transitioned from one cohort to another across a date frame chosen by the user (for example: how many profiles transitioned from Champion to Needs Attention in the past 30 days);

To provide: median performance of each cohort (e.g., what is the median spend of my “Champions” cohort);

To provide profile-level attributes so that merchants can send communication through email, SMS, or push notifications conditional on the RFM cohort to which a profile belongs;

To provide the ability to customize the parameters of the RFM cohort definitions, allowing users to tailor the groupings to best suit the nature of their business and their marketing strategy;

To provide “smart default” definitions, so that merchants are set up with a reasonable starting point that aligns with the nature of their business; and

To provide preview functionality which allows users to preview a change to their RFM definition parameters by viewing the analytics dashboard with the new settings before they lock in those settings and affect the profile-level attributes.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

The present subject matter is illustrated by way of example, and not by way of limitation, in the figures of the accompanying drawings in which:

FIG. 1 shows a system for storing user-defined query logic in a database for filtering entity data, according to an embodiment.

FIG. 2 is a flow chart of a method for storing user-defined query logic in a database for filtering entity data, according to an embodiment.

FIG. 3 shows tables of profile data, according to an embodiment.

FIG. 4 shows tables of user-defined segment definitions, according to an embodiment.

FIG. 5 shows additional tables of user-defined segment definitions, according to an embodiment.

FIG. 6 shows a user interface of a system for storing user-defined query logic in a database for filtering entity data, according to an embodiment.

FIG. 7 is a flow chart of a method for computing a sub-user profile property for filtering entity data, according to an embodiment.

FIG. 8 shows a system for computing a sub-user profile property for filtering entity data, according to an embodiment.

FIG. 9 is another flow chart that includes steps of a method for computing a sub-user profile property for filtering entity data, according to an embodiment.

FIG. 10 shows a table of a mapping matrix for the computed sub-user profile properties, according to an embodiment.

FIG. 11 shows a table of a distribution of the sub-user profiles based on a vector mapping, according to an embodiment.

FIGS. 12-13 are various charts illustrating the change over time of the computed profile property for the sub-user profiles, according to embodiments.

FIGS. 14-15 are user interfaces for accepting user modifications to the scoring vectors, according to embodiments.

FIG. 16 is a flow chart of a method for sending electronic messages based on a computed sub-user profile property, according to an embodiment.

FIG. 17 is a flow chart of a method for sending electronic messages, after a trigger event, based on a computed sub-user profile property, according to an embodiment.

FIG. 18 is a user interface for defining a group of sub-users based on a computed sub-user profile property, according to embodiments.

FIG. 19 is a user interface for preparing content of an electronic message based on a computed sub-user profile property, according to an embodiment.

### DETAILED DESCRIPTION

The embodiments described include methods, apparatuses, and systems for storing user-defined query logic in a database for filtering entity data. For an embodiment, this includes storing the transformed new user-defined segment definitions in the database, composing a user-defined query based on the transformed new user-defined segment definitions as stored in the database, and running the composed user-defined query against data tables to determine which of the entities qualify for membership in new segments based on each of the new user-defined segment definitions as determined by the logic contained in the composed user-defined query. An electronic action (such as sending an electronic message) is performed directed to sub-users identified by membership in the new segments.

Typically, segments are based on user-defined sets of rules for filtering data in a database. If the data is stored in a single analytical database, then a natural solution is to write SQL (structured query language) queries to calculate segment memberships based on this data. It is desirable to express the user-defined rule sets in the SQL queries. Structured query language (SQL) is a programming language for storing and processing information in a relational database. A relational database stores information in tabular form, with rows and columns representing different data attributes and the various relationships between the data values. SQL statements can be used to store, update, remove, search, and retrieve information from the database. SQL can also be used to maintain and optimize database performance.

One way to do this is to build the query string in code based on a list of rules of a user. However, building a syntactically correct SQL query this way is difficult and error-prone, and is also vulnerable to SQL injection attacks if the user-provided strings are not properly sanitized to remove malicious inputs. This method is also not practical if the user wants to run more than one segment simultaneously, which is required when keeping segments up to date in real time.

At least some of the described embodiments include storing a rule set (transformed new user-defined segment definitions) of the user in the database making the query itself generic. Therefore, any number of segments can be evaluated simultaneously in one SQL query, and the system is protected from SQL injection attacks since the query is not being pieced together from user-provided strings. That is, at least some of the described embodiments provide a technical solution to the technical problem of evaluating multiple segments simultaneously in a single query (for example, a single SQL query). Further, the operation of the computer or processor performing at least some of the described embodiments is improved by reducing the possibilities of SQL injection attacks when performing an SQL query of the database in which data being segmented is stored. SQL injection (SQLi) is a web security vulnerability that allows an attacker to interfere with the queries that an application makes to its database. This can allow an attacker to view data that they are not normally able to retrieve. This might include data that belongs to other users, or any other data that the application can access. In many cases, an attacker can modify or delete this data, causing persistent changes to the application's content or behavior.

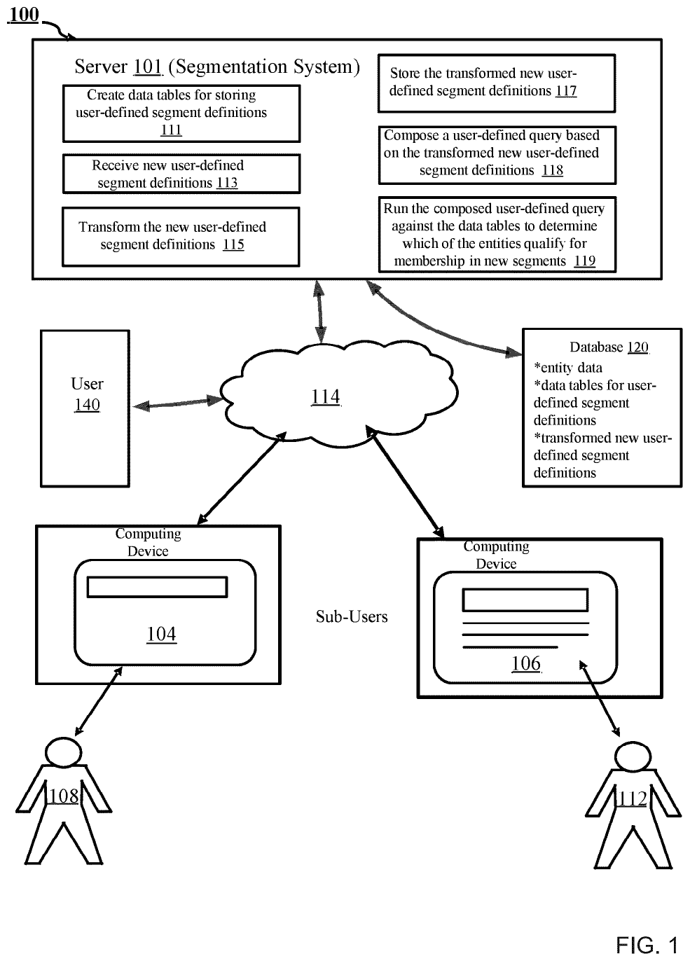

FIG. 1 shows a system 100 for storing user-defined query logic in a database for filtering entity data, according to an embodiment. As shown, for an embodiment, the system includes a segmentation server 101 and an associated database 120. For an embodiment, the segmentation server 101 is electronically connected through a network (for example, the internet) 114 to user server 140 of a user, and to computing devices 104, 106 of sub-users 108, 112. For an embodiment, the user is a merchant, and the sub-users are customers of the merchant. For an embodiment, one or more of the entities include a profile of the sub-users (customers) of the user (merchant) 108, 112, which can be added to the database 120 through means including integrations with third-party platforms (including ecommerce providers or external customer data platforms, for example), API calls from the user's own computer systems, websites, or mobile apps, or user-initiated file uploads to the server 101. For other embodiments, one or more of the entities may include entries in a user's catalog of items for sale; user-defined custom entities such as restaurant reservations, gift cards, or event tickets; or coupon codes and associated metadata. For an embodiment, the profiles of the entities come from another platform that customers of an operator of the server integrate into their system. For example, an ecommerce provider like Shopify®, a third-party point-of-sale system in a brick-and-mortar store, or a third-party customer data platform (CDP). They can also be created by uploading files of profile data to an application or by API calls to the application (for example, from a user's own mobile application or their website).

For an embodiment, the user of the user server 140 may initiate a segmentation process of information related to the sub-users. For example, the user may desire segmentation of email addresses of the sub-users for facilitating targeted emailing of advertising. For an embodiment, a profile of each of the sub-users is stored in the database. For an embodiment, the segmentation includes analyzing information within the profiles of the sub-users to filter the sub-users based on a user-provided criteria, which can include criteria like “profiles located in New York,” “profiles that have purchased at least 2 pairs of red pants in the last 6 months,” or “profiles whose pre-computed probability of placing an order in the next 30 days is greater than 50%” or combinations of criteria such as these.

For an embodiment, the server 101 is configured to filter entities (for an embodiment, the entities each include the previously mentioned profiles) within the database 120 based on rules of a user-defined segment definition applied to various data points associated with each entity stored in the database. For an embodiment, this includes the server 101 operating to create 111 data tables for storing user-defined segment definitions in the database, the data tables including the user-defined segment definitions and criteria, wherein the user-defined segment definitions include lists of references to the criteria, wherein the criteria include rules that are evaluated against entity data of the database to determine whether an entity should or should not qualify for a segment based on entity data associated with the entity. For an embodiment, the results of the criteria are logically aggregated using Boolean operators (AND or OR).

For an embodiment, the server 101 further operates to receive 113 new user-defined segment definitions. For an embodiment, the new user-defined segment definition is received by the server 101 from the user server 140 of the user for the purpose of generating a new segmentation process.

For an embodiment, the server 101 further operates to transform 115 the new user-defined segment definitions, wherein transforming includes representing the new user-defined segment definitions as sets of filter definition tuples, wherein the sets of filter definition tuples are based on the user-defined segment definitions and the criteria in the created data tables. For an embodiment, each of the criteria includes a definition that is a list of generic filter definition tuples. For an embodiment, the sets of filter definition tuples include conditions that must be met by a given event or trait (of the entities) for the entity (profile) to qualify for the criteria. There are a few variations in the filter tuple schema, but for an embodiment, the sets of filter definition tuples are of the form (key, operator, value) or (type, key, operator, value). An exemplary filter may include “(‘some_property’, ‘eq’, 1234)” which is conceptually similar to an SQL “where” clause like “where some_property 1234”. The type field may be included to allow properties to be treated as or cast to different types at query time, which is important since an operator of the server 101 may not enforce a rigid, typed schema on customer-provided data.

For an embodiment, each filter tuple column is of an array type. When multiple filter tuples are present, they must all be satisfied together. That is, the filter tuples are combined with an AND Boolean operator.

While described as sets of filter definition tuples, at least one embodiment includes replacing the sets of filter definition tuples with a separate table with a row for each member of the set of filter definition tuples and a column for each field in each the set of filter definition tuples, which can be joined to the remaining parts of the user-defined segment definition.

For an embodiment, the server 101 further operates to store 117 the transformed new user-defined segment definitions in the database. As previously described, at least some of the described embodiments include storing a rule set of the user (that is, the transformed new user-defined segment definitions) in the database making the query itself generic. That way, any number of segments can be evaluated simultaneously in one SQL query, and the system is protected from SQL injection attacks since the query is not being pieced together from user-provided strings. That is, at least some of the described embodiments provide a technical solution to the technical problem of evaluating multiple segments simultaneously in a single query (for example, a single SQL query). Further, the operation of the computer or processor performing at least some of the described embodiments is improved by reducing the possibilities of SQL injection attacks when performing an SQL query of the database in which data being segmented is stored.

For an embodiment, the server 101 further operates to compose 118 a user-defined query based on the transformed new user-defined segment definitions as stored in the database, wherein the user-defined query contains logic that interprets the sets of filter definition tuples and performs the SQL operation or function call that is represented by each filter tuple of the sets of filter definition tuples. For example, a filter tuple “(‘price’, ‘gt’, ‘50’)” may be interpreted as a SQL condition “WHERE price>50”, or a filter tuple “(‘email’, ‘ends-with’, ‘example.com’)” may be interpreted as a SQL condition “WHERE endsWith(email, ‘example.com’)” (assuming the database provides a built-in function “endsWith” for this purpose). This enables calls to functions to be built into the SQL implementation provided by the database. Another way of saying this is that this is where the filter tuples become standard SQL, but in a way that is not prone to SQL injection attacks.

For an embodiment, the server 101 further operates to run 119 the composed user-defined query against the data tables to determine which of the entities qualify for membership in new segments based on each of the new user-defined segment definitions as determined by the logic contained in the composed user-defined query. For an embodiment, the operation of running the composed user-defined query consists of running a predefined SQL query that combines the criteria to evaluate from the criterion tables with the data from the entity data tables to determine which entities qualify for membership in the segment. As previously described, the sets of filter definition tuples are based on the user-defined segment definitions and the criteria in the created data tables.

For an embodiment, the segmentation process includes implementing filters using user-defined SQL functions in an analytical database. These are essentially large if/else trees with a case for each operator, where the operators include simple things like “eq” (equals), “gt” (greater than), or “contains”, but also more complex things like conditions on time relative to now (“in-the-last”, “anniversary-in-the-next”).

For an embodiment, at query time (running the composed user-defined query), segment definitions are used to filter entity (profile) data and event histories to decide if profiles belong in the segments. In general, many segments are evaluated simultaneously. For an embodiment, desired definitions from the tables described are selected, and these definitions are joined to pre-filtered subsets of the event and trait data tables in the analytical database. An embodiment includes pre-filtering to select only the subset of data that is relevant for the set of segments being evaluated.

For an embodiment, for event data, each event is filtered first on its properties by iterating over each property filter tuple, evaluating it using the filtering functions, and combining the results with an AND. Events that don't satisfy the filter are removed from consideration. The remaining events are then grouped by the entity they are related to, and the event count and total event value are aggregated, where the event value corresponds to things like the price of purchased items. Filters on the event count or total event value are then applied to these aggregates, and this determines whether or not an entity (profile) qualifies for this event criterion. As previously described, the profile may be of one of the sub-users of the user.

For an embodiment, a similar procedure is followed as trait criteria as the property criterion. The trait data is loaded, and the properties associated with that trait are filtered like the event properties were filtered above. For an embodiment, the difference is that there is only one trait row for each profile and trait type, so there's no aggregation involved. If the trait row passes the combined property filters, then the profile qualifies for this criterion. Finally, criterion results are combined to give the overall segment results.

For an embodiment, the entity or entities include something that the data in the data tables is associated with, and which can qualify for membership in a segment based on the user-defined segment definition. As described, for an embodiment, each entity is a profile. However, for at least some other embodiment, an entity may include catalog items sold by an ecommerce store, or user-defined objects representing things like concert tickets, coupons, or appointment bookings.

For at least some embodiments, segments or a segment include a list of entities whose membership is determined by evaluating the composed user-defined query based on the user-defined segment definition.

For at least some embodiments, the user-defined segment definitions include a collection of rules determining the membership of a segment, where the rules can be transformed into sets of filter definition tuples.

For an embodiment, the data points associated with each profile/entity include profile activity history (recorded events for things like receiving an email, placing an order, viewing a product on the customer's website, etc., including user-defined custom event types). For an embodiment, the data points associated with each profile/entity include attributes specific to the profile (called profile “traits”), including, for example, the profile's contact information (email, phone number, push notification tokens, etc.), location data (mailing addresses, IP addresses, locations derived from IP addresses, time zone, etc.), consent to receive marketing communications, memberships in certain mailing lists, other values derived from machine learning algorithms, etc.

For an embodiment, data points for other types of entity are different, but have a similar structure. For example, entities representing catalog items might have traits for the inventory of that item in stock and attributes about the item like its size or color, and the events for these catalog item entities might include changes in inventory level.

For an embodiment, the data tables are tables in a database that contain the event and trait data associated with each entity, or the user-defined segment definitions (after the transformation), or the criteria that make up the definition. For an embodiment, this includes, for example, a criterion based on the entity's event history and a criterion based on properties about the entity.

For an embodiment, the criteria include rules that are evaluated as part of a user-defined segment definition. For at least some embodiments, the rules include one or more of a profile's email address ends with “example.com”, a profile's phone number is not blank, a profile has given consent to receive SMS marketing messages, a profile has placed orders in the last 6 months whose total revenue is greater than $1000, a profile has ordered a product with the category “Pants” at least 4 times between Mar. 1, 2023, and Aug. 6, 2023, a profile's location is within 10 miles of the postal code 12345 in the United States.

As previously described, for an embodiment, each entity includes a profile. For an embodiment, a profile represents a person (sub-user) who the user can communicate with or collect information about. For example, if the user runs an ecommerce store, the profile represents a single customer (sub-user) of that store.

For an embodiment, lists of references to the criteria include lists of the IDs of criteria, where each ID is an arbitrary and unique value that can be used to unambiguously refer to a single criterion.

For an embodiment, a set of filter definition tuples include a set of transformed representations of the criteria. These map directly to operations that the database knows how to perform. For example:
Criterion: Profile's email address ends with “example.com”
   Tuple: (“email”, “ends-with”, “example.com”)
      DB operation (pseudocode): WHERE endsWith(email, “example.com”)
Criterion: Profile has ordered a product with the category “Pants” at least 4 times between Mar. 1, 2023, and Aug. 6, 2023
   Tuple: (“Category”, “eq”, “Pants”)
      DB operation: WHERE Category=“Pants”
   Other tuple (very roughly): (“count”, “gte”, 4)
      DB operation: HAVING count( )>=4

For an embodiment, logic that implements the sets of filter definition tuples as calls to functions implemented by the database.

For at least some embodiments, the user-defined segment definitions include the criteria and rules for combining the results of these criteria with Boolean operations AND and OR. For an embodiment, the composed user-defined query aggregates the results by entity and user-defined segment to find all entities that qualify for the user-defined segment based on the rules from the segment definition for combining the results of the criteria. For example, this may include grouping together some criteria with a Boolean OR operation, and then combine the result of this with other criteria using a Boolean AND operation.

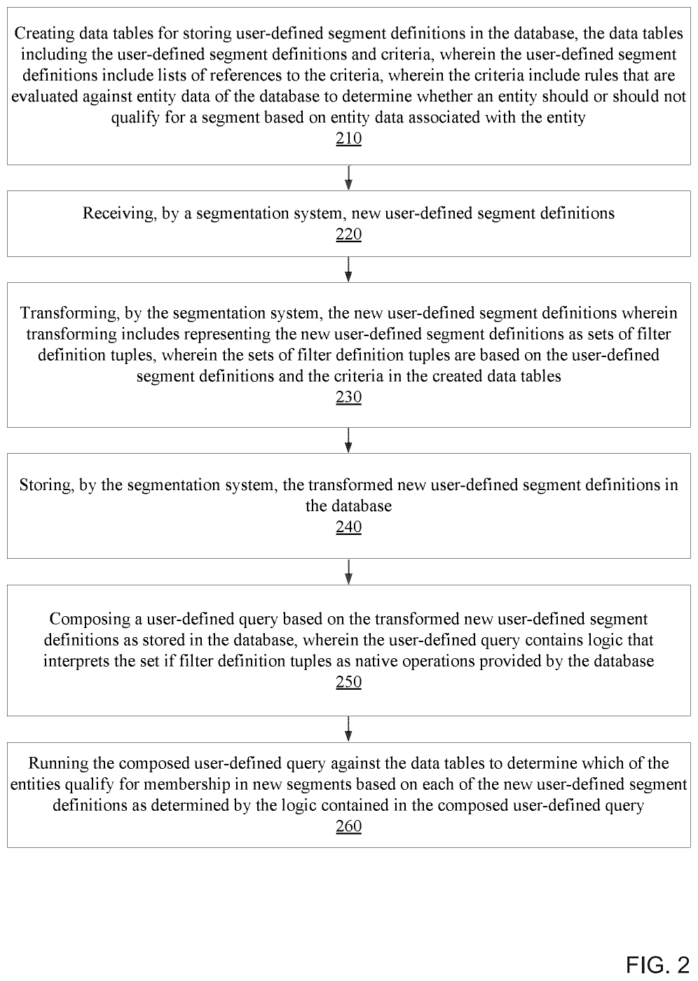

FIG. 2 is a flow chart that includes steps of a method for storing user-defined query logic in a database for filtering entity data, according to an embodiment. A first step 210 includes creating data tables for storing user-defined segment definitions in the database, the data tables including the user-defined segment definitions and criteria, wherein the criteria include rules that are evaluated against entity data of the database to determine whether an entity should or should not qualify for a segment based on entity data associated with the entity. For an embodiment, the user-defined segment definitions include lists of references to the criteria and operators. For an embodiment, the operators include, for example, “equals”, “greater than”, or “less than.” For an embodiment, the criteria include sets of (attribute name, operator, value), such as, (email, equals, “something@something.com”). A second step 220 includes receiving, by a segmentation system, new user-defined segment definitions. A third step 230 includes transforming, by the segmentation system, the new user-defined segment definitions, wherein transforming includes representing the new user-defined segment definitions as sets of filter definition tuples, wherein the sets of filter definition tuples are based on the user-defined segment definitions and the criteria in the created data tables. A fourth step 240 includes storing, by the segmentation system, the transformed new user-defined segment definitions in the database. A fifth step 250 includes composing a user-defined query based on the transformed new user-defined segment definitions as stored in the database, wherein the user-defined query contains logic that interprets the sets of filter definition tuples as native operations provided by the database. For an embodiment, native operations include operations built into the database as opposed to being separately defined. A sixth step 260 includes running the composed user-defined query against the data tables to determine which of the entities qualify for membership in new segments based on each of the new user-defined segment definitions as determined by the logic contained in the composed user-defined query. For an embodiment, the segmentation of the entities provides a filtered set of entities per the new user-defined segment definitions.

As previously described, while described as sets of filter definition tuples, at least one embodiment includes replacing the sets of filter definition tuples with a separate table with a row for each member of the set of filter definition tuples and a column for each field in each the set of filter definition tuples, which can be joined to the remaining parts of the user-defined segment definition.

### Transforming New User-Defined Segment Definitions

As previously stated, an embodiment includes transforming, by the segmentation system, the new user-defined segment definitions, wherein transforming includes representing the new user-defined segment definitions as sets of filter definition tuples, wherein the sets of filter definition tuples are based on the user-defined segment definitions and the criteria in the created data tables. As previously described, for an embodiment, each of the criteria includes a definition that is a list of generic filter definition tuples. For an embodiment, the sets of filter definition tuples include conditions that must be met by a given event or trait (of the entities) for the entity (profile) to qualify for the criteria. There are a few variations in the filter tuple schema, but for an embodiment, the sets of filter definition tuples are of the form (key, operator, value) or (type, key, operator, value). An exemplary filter may include “(‘some_property’, ‘eq’, 1234)” which is conceptually similar to an SQL “where” clause like “where some_property=1234”. The type field may be included to allow properties to be treated as or cast to different types at query time, which is important since an operator of the server 101 may not enforce a rigid, typed schema on customer-provided data. For an embodiment, events are actions that a profile has taken, like placing an order, receiving an email, and/or opening an SMS message.

### Composing the User-Defined Query

As previously stated, an embodiment includes composing a user-defined query based on the transformed new user-defined segment definitions as stored in the database, wherein the user-defined query contains logic that interprets the sets of filter definition tuples as native operations provided by the database. For an embodiment, native operations include operations built into the database as opposed to being separately defined. Further, as previously described, for an embodiment, the user-defined query contains logic that interprets the sets of filter definition tuples and performs the SQL operation or function call that is represented by each filter tuple of the sets of filter definition tuples. For example, a filter tuple “(‘price’, ‘gt’, ‘50’)” may be interpreted as a SQL condition “WHERE price>50”, or a filter tuple “(‘email’, ‘ends-with’, ‘example.com’)” may be interpreted as a SQL condition “WHERE endsWith(email, ‘example.com’)” (assuming the database provides a built-in function “endsWith” for this purpose). This enables calls to functions to be built into the SQL implementation provided by the database. Another way of saying this is that this is where the filter tuples become standard SQL, but in a way that is not prone to SQL injection attacks.

### Running the Composed User-Defined Query

As previously stated, an embodiment includes running the composed user-defined query against the data tables to determine which of the entities qualify for membership in new segments based on each of the new user-defined segment definitions as determined by the logic contained in the composed user-defined query. As previously described, for an embodiment, the operation of running the composed user-defined query consists of running a predefined SQL query that combines the criteria to evaluate from the criterion tables with the data from the entity data tables to determine which entities qualify for membership in the segment. As previously described, the sets of filter definition tuples are based on the user-defined segment definitions and the criteria in the created data tables. Structured query language (SQL) is a programming language for storing and processing information in a relational database. A relational database stores information in tabular form, with rows and columns representing different data attributes and the various relationships between the data values. SQL statements can be used to store, update, remove, search, and retrieve information from the database. SQL can also be used to maintain and optimize database performance. For an embodiment, the database query (such as the composed user-defined query) is a request for data from the database. The request comes in a database table or a combination of tables using a code known as the query language. This way, the database can understand and process the query accordingly.

At least some embodiments further include electronically performing an action directed to sub-users identified by membership in the new segments. For an embodiment, the action includes electronically messaging sub-users that were filtered by the composed user-defined query. For at least some embodiments, the segments are created to target marketing email and/or SMS messages to a group of people based on the conditions in the segment definition.

For an embodiment, each of the entities comprises a profile, wherein each profile represents a person (sub-user) that the user can communicate with or collect information about. For example, if the user runs an ecommerce store, the profile represents a single customer (sub-user) of that store.

For an embodiment, each segment includes a list of entities, wherein membership of each of the entities is determined by the composed user-defined query based on the new user-defined segment definitions. For an embodiment, one or more of the entities include a profile of the sub-users (customers) of the user (merchant), which can be added to the database through means including integrations with third-party platforms (including ecommerce providers or external customer data platforms, for example), API calls from the user's own computer systems, websites, or mobile apps, or user-initiated file uploads to the server. For other embodiments, one or more of the entities may include entries in a user's catalog of items for sale; user-defined custom entities such as restaurant reservations, gift cards, or event tickets; or coupon codes and associated metadata. For an embodiment, the profiles of the entities come from another platform that customers of an operator of the server integrate into their system. For example, an ecommerce provider like Shopify®, a third-party point-of-sale system in a brick-and-mortar store, or a third-party customer data platform (CDP). They can also be created by uploading files of profile data to an application or by API calls to the application (for example, from a user's own mobile application or their website).

For at least some embodiments, running the composed user-defined query provides for filtering for multiple segments simultaneously. This is possible because the transformed new user-defined segment definitions are stored in the database and read at query time. For an embodiment, the query is written to interpret these filter definition tuples (rules) stored in the database and executes them as standard SQL/Database functions. For an embodiment, the query knows how to interpret the text (tuples) stored in the database and execute them as query logic.

At least some embodiments further include creating and storing a trait and event table in the database as a part of the entity data of the data tables. For an embodiment, the entity data includes an email address of a sub-user. For an embodiment, traits are properties of a profile. This is generally things that profiles have only a few of, and things that are not filtered based on the number of. Traits may include email, phone number, properties, and/or a subscription status.

For an embodiment, the entity data includes time-series data. For an embodiment, the time-series data includes at least one of a purchase history or an email history of a sub-user. For an embodiment, a profile (entity) may have data points that are associated 1:1 with the profile, like an email address or a postal address. However, for an embodiment, the profile may also have time-series data associated with it, including event timelines like purchase history or a history of emails received.

At least some embodiments further include updating the overall segments as entity data changes. For an embodiment, updating the overall segments as entity data changes includes sensing changes in the entity data, and automatically re-running the composed user-defined query against the data tables to determine which of the entities qualify for membership in new segments based on each of the new user-defined segment definitions as determined by the logic contained in the composed user-defined query. For an embodiment, sensing greater than a change threshold of changes to the entity data triggers the updating of the overall segments.

At least some embodiments further include electronically sending messages to sub-users identified by membership in new segments. This may include sending emails, SMS messages, push notifications, or other communications to targeted audiences of people (sub-users).

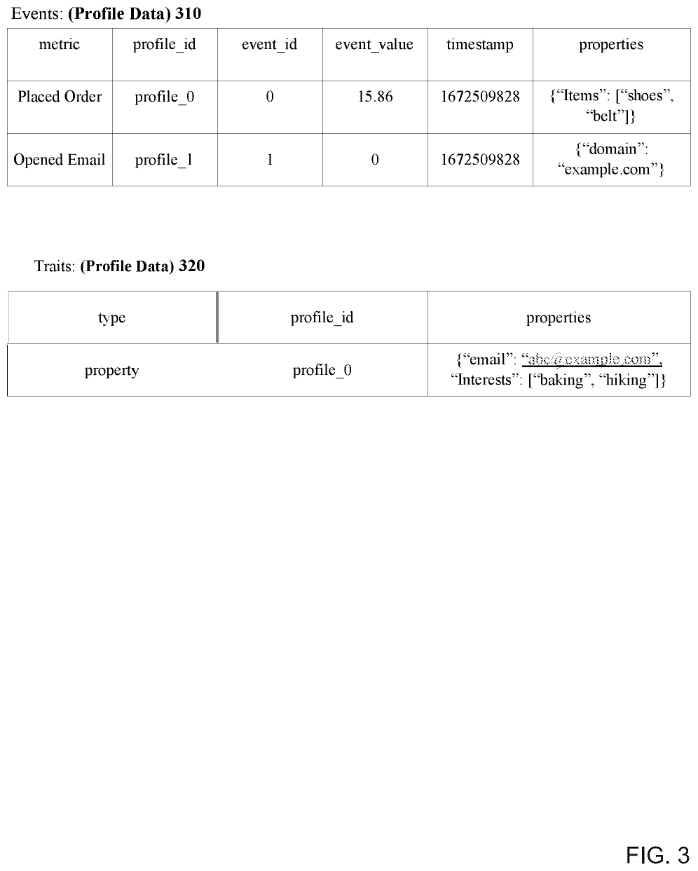

FIG. 3 shows tables of profile data, according to an embodiment. As previously described, for an embodiment, each entity includes profile data. As shown, for an embodiment, the profile data includes events data 310 which can include a metric, an event_id, an event_value, a timestamp, and properties.

Further, as shown, for an embodiment, the profile data includes traits data 320 which include, for example, a type, a profile_id, and properties.

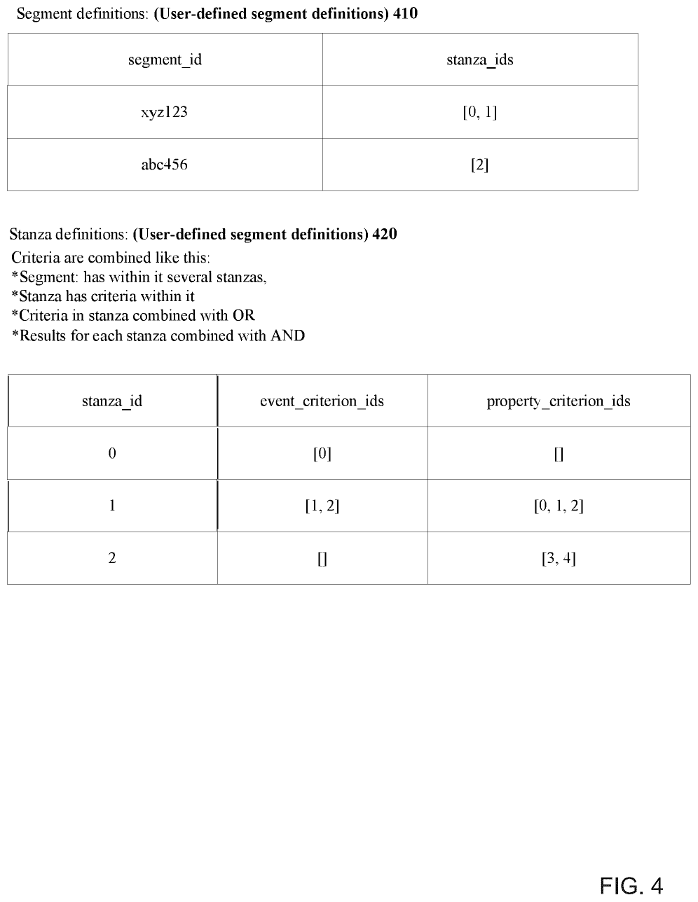

FIG. 4 shows tables of user-defined segment definitions 410, 420, according to an embodiment. The user-defined segment definitions 410 includes a segment_id and a stanza_id. For an embodiment, the user-defined segment definitions 420 includes a stanza_id, event_criterion_ids, and property_criterion_ids. For an embodiment, these IDs are all randomly chosen values that allow for cross-referencing the stanzas, criteria, and segments and linking them together.

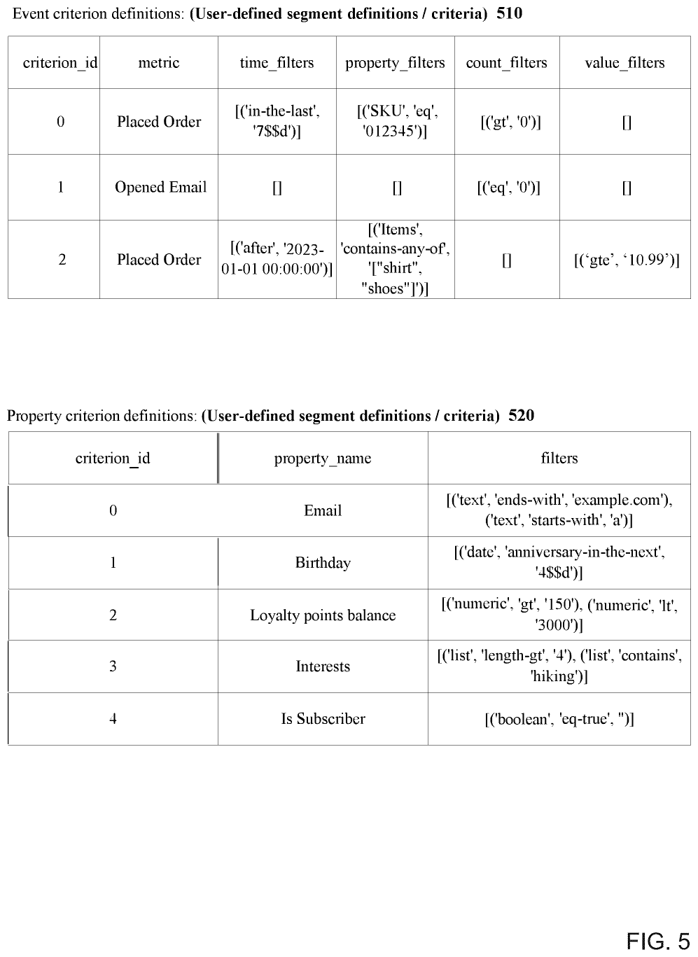

FIG. 5 shows additional tables of user-defined segment definitions, according to an embodiment. Examples of filter tuples are shown between square brackets in the right-most columns of each table. Each filter tuple is enclosed in parentheses.

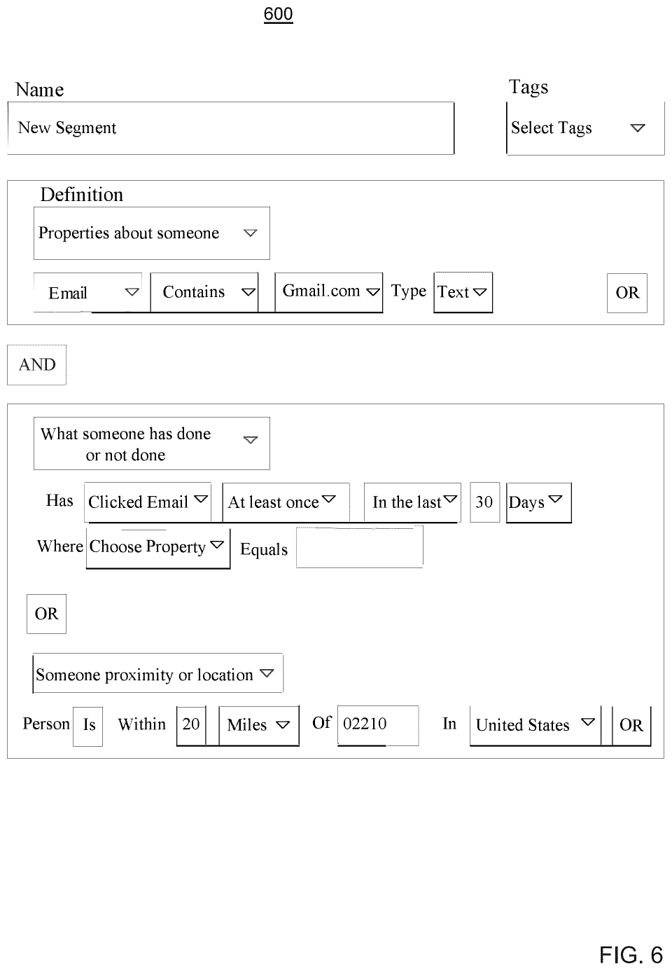

FIG. 6 shows a user interface 600 of a system for storing user-defined query logic in a database for filtering entity data, according to an embodiment of the invention.

### Computing Recency, Frequency, and Monetary Value Sub-User Profile Properties

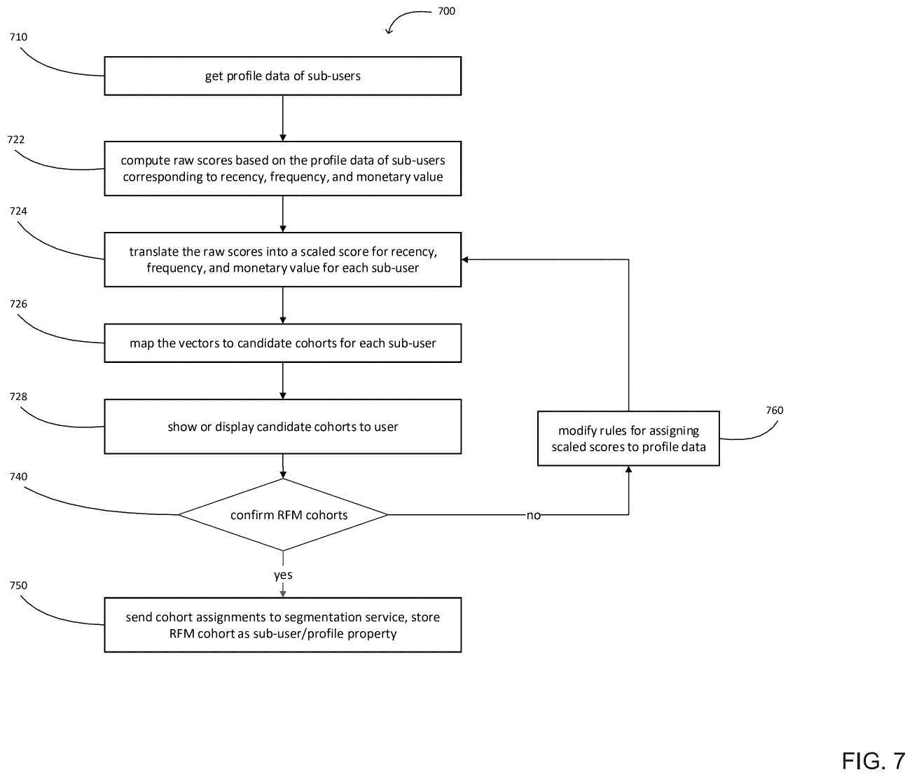

FIG. 7 is a flow chart of a method 700 for storing user-defined query logic in a database for filtering entity data based on computed recency, frequency, and monetary value (RFM) properties, according to an embodiment.

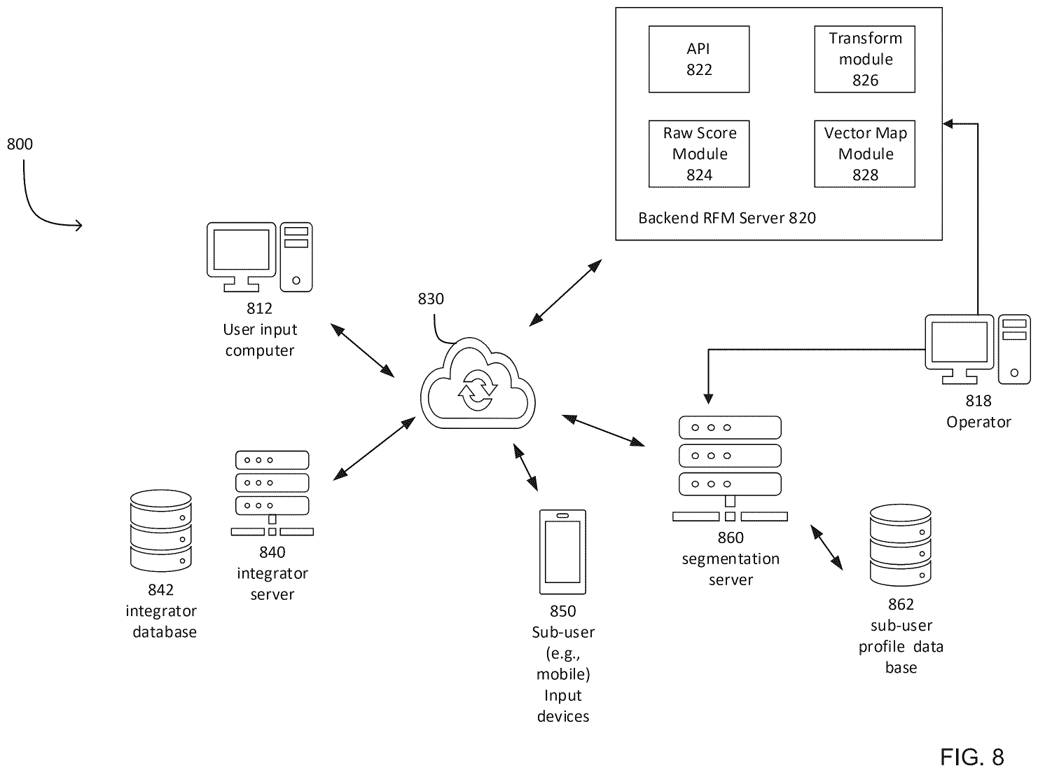

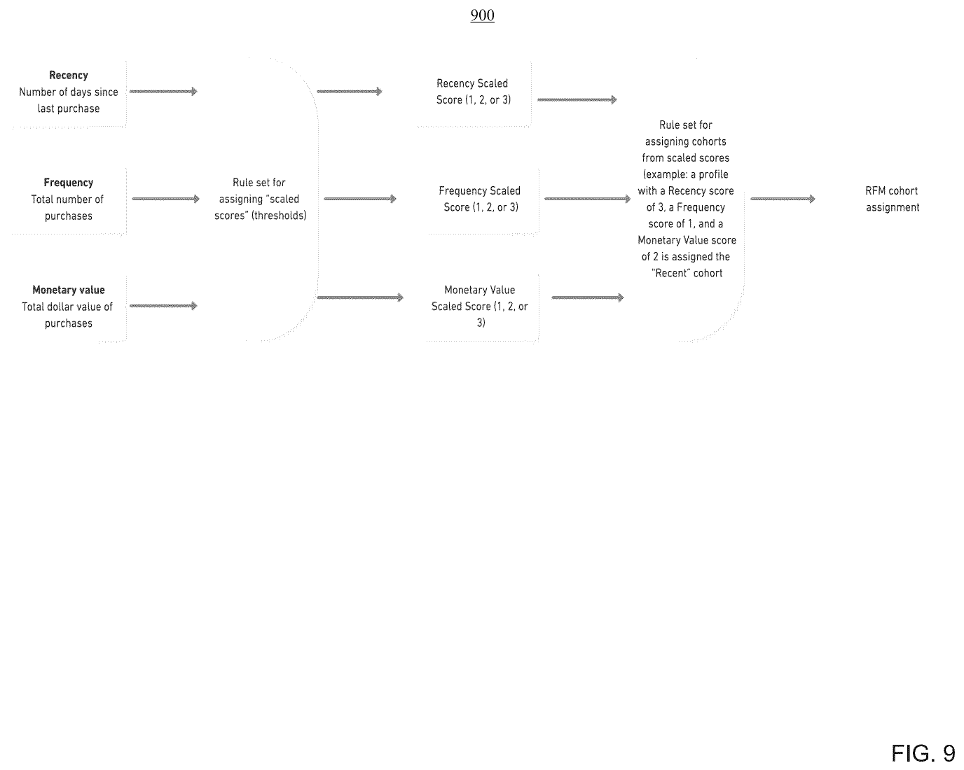

A first step 710 states getting or obtaining data of sub-users. With reference to FIG. 8, this step may be performed by backend server 820 obtaining sub-user profile data from the segmentation server and database 860, 862. Examples of sub-user profile data 862 include a wide range of information as described above in connection with FIG. 3.

For an embodiment, traits are properties of a profile. Profiles generally only have a few traits, and traits are generally not filtered by count. Traits may include email, phone number, a subscription status, and properties such as RFM cohort as described herein.

Step 722 states to compute raw scores based on the profile data of sub-users corresponding to recency, frequency, and monetary value metrics. This step may be performed by the raw score module 824 of server 820. In embodiments, for each sub-user, the recency is the number of days since last purchase; the frequency is the number of purchases; and the monetary value is the total dollar value of purchases. This data is collected for each sub-user and stored in a database associated with the server.

Step 724 states to translate the raw scores into a scaled score for recency, frequency, and monetary value for each sub-user. In embodiments, the transform module 826 of server 820 is operable to assign each sub-user a scaled score from 1 to 3 on each dimension, where 3 represents high value and 1 represents low value. For example, consider a sub-user who has made a lot of purchases and spent a lot of money, but has not placed an order in a long time. That sub-user might be a 1 for Recency, a 3 for Frequency, and a 3 for Monetary Value. Ultimately, each sub-user can be represented as a vector of their scores for R, F, and M. The sub-user in the preceding example could be represented as (1, 3, 3). Since there are three possible scores for each of the three dimensions, there are 27 possible vectors to represent a customer.

Translating a raw score into a scaled score can be carried out in various manners. In embodiments, the server is programmed and operable to compile the raw scores and compute the scaled scores by application of various statistical or algebraic rules.

In embodiments, for the frequency scaled score, the server automatically computes the low threshold ‘a’ (e.g., 33^{rd} percentile) and a high threshold ‘b’ (e.g., 66th percentile) for number of orders among sub-users (namely, profiles) within the user (namely, merchant). Then, the frequency scores for a given sub-user are computed as follows: if the sub-user's number of orders is less than or equal to the low threshold ‘a’, assign a score of 1; if the sub-user's number of orders is greater than the low threshold ‘a’ but less than or equal to max(a+1, b), assign a score of 2; and otherwise, assign a score of 3.

In embodiments, for the monetary value scaled score, the server automatically computes the low threshold ‘a’ (e.g., 33^{rd} percentile) and a high threshold ‘b’ (e.g., 66th percentile) for total lifetime spend among sub-users (namely, profiles) within the user (namely, merchant). Then, the monetary scaled score for a given sub-user is computed as follows: if the sub-user's total spend is less than or equal to the low threshold ‘a’, assign a score of 1; if the sub-user's total spend is greater than the low threshold ‘a’ but less than or equal to the high threshold ‘b’, assign a score of 2; and otherwise, assign a score of 3.

In embodiments, for the recency scaled score, the server automatically computes the average days between orders for each sub-user within the user (namely, merchant). The server then computes a first and second threshold, corresponding to the a^{th} percentile and b^{th} percentile, respectively, for average days between orders across all sub-users. In embodiments, the first threshold ‘a’ ranges from 40-60^{th} percentile and in some embodiments ranges from 45-55^{th} percentile. In embodiments, the second threshold is at least 90^{th} percentile, and in some embodiments is at least 95^{th} percentile. Then, the recency scores for a given sub-user are computed as follows: if the sub-user's days since last order is less than or equal to the first threshold (‘a’), assign a score of 3; if the sub-user's days since last order is greater than the first threshold but less than or equal to the second threshold (‘b’), assign a score of 2; and otherwise, assign a score of 1.

Without intending to be bound to theory, the inventors have found computing recency as described above is more representative or meaningful than conventional methods because it takes into consideration that the vast number of purchases are one-time purchases which tend to bias or thwart the recency score, which in turn decreases the value of the RFM computation.

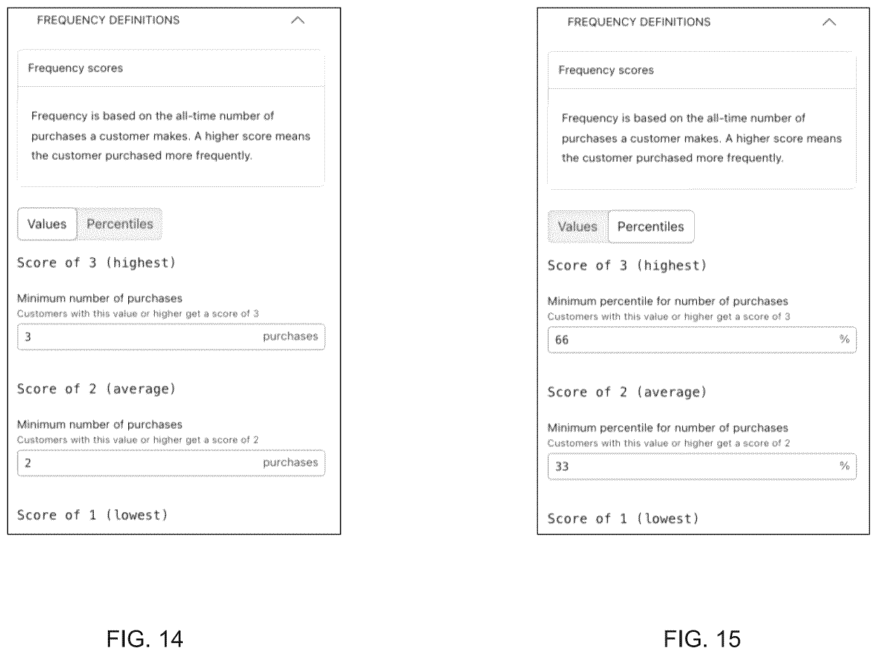

In embodiments, a number of different transformation models are provided including a static model which does not vary from user to user, and a variable model which is based on entity date for the user such as the total number of sub-user events for the user (e.g., average number of orders for all sub-users for a user, average days between purchase for all sub-users for the user, and total lifetime spend among all sub-users for the user). In embodiments, the scaled scores are computed for multiple types of translation approaches. As described herein, the user can pre-view the results or a portion of the results and select a type of translation model based on the pre-viewed results. Additionally, as described herein in connection with FIGS. 14, 15, in embodiments, the user can adjust various parameters (e.g., raw score ranges for the scaled score) to modify the scaled scores generated by the translation model.

Although several transformation models are described above to convert or process the raw scores into the scaled scores, the invention is not intended to be so limited except where explicitly recited in any appended claims.

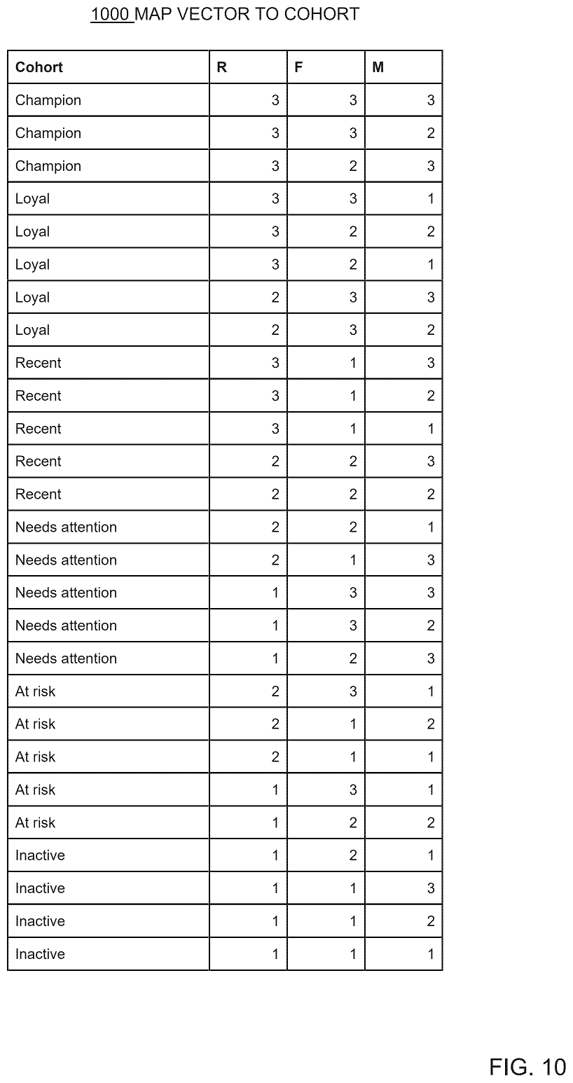

Step 726 states to map the vectors to candidate RFM cohorts for each sub-user. In embodiments, a vector map module 828 of the server 820 is programmed and operable to map each sub-user to the appropriate cohort based on their vector of scores. In embodiments, and with reference to FIG. 10, there are 6 cohorts—“Champions”, “Loyal”, “Recent”, “Needs Attention”, “At Risk”, and “Inactive” and a predefined mapping of vectors to cohorts. For example, a sub-user with a score vector of (3, 3, 3), (3, 2, 3), or (3, 3, 2) will be assigned the cohort of “Champion”. This step is performed automatically by the server 820 based on the vector of scores.

In some embodiments, the predefined mapping matrix for mapping vectors with cohorts as shown in FIG. 10 is built based on survey data from multiple users. In some embodiments, the predefined mapping matrix is customized for one user based on the user's preferences. In some embodiments, the server is programmed and operable to request the user for preferred cohorts for one or more vectors. In some embodiments, the predefined mapping matrix is built based on the operator's preferences, wherein the operator inputs the preferred cohorts for each vector. In some embodiments, the mapping matrix is universal and applied to all users, and in some embodiments, the mapping matrix is customized for a user. Indeed, there are several processes or strategies for building and applying the mapping matrix, and the invention is only intended to be limited as recited in any appended claims.

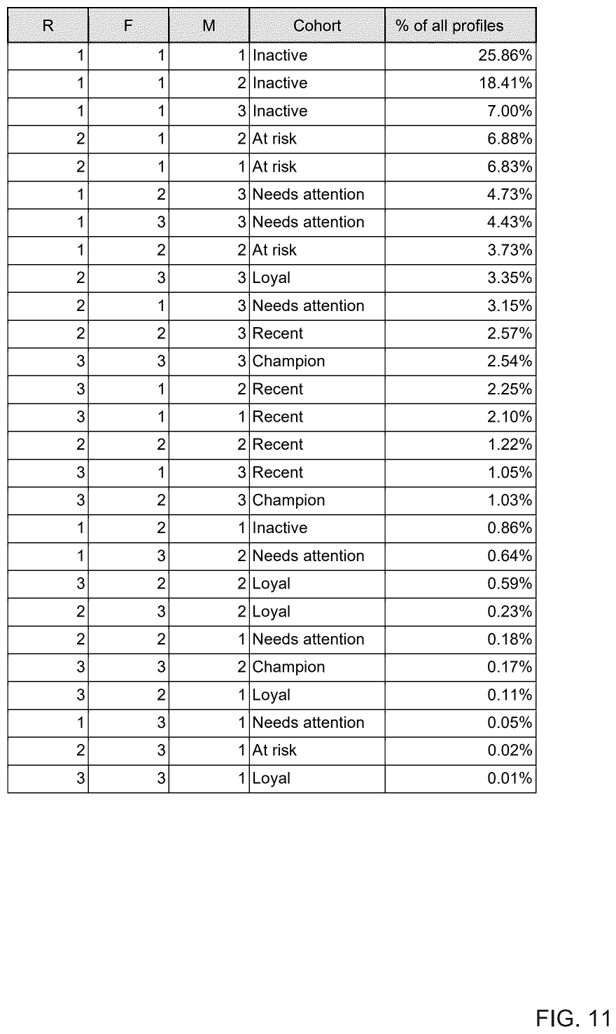

FIG. 11 illustrates in tabular format the distribution of the sub-users by cohort based on the mapping model described in FIG. 10. The data indicates that the distribution was not even. For example, the (3, 3, 1) vector is going to be very rare (0.01% according to the table shown in FIG. 11) because, unsurprisingly, most sub-users who qualified for a score of 3 in Frequency would also qualify for at least a 2 in Monetary Value. This would consequently result in a different vector score.

Step 728 states to show or display candidate cohorts to user. This step may be performed by an API 822 of the backend server 820, which is operable with the user's device 812 (whether desktop computer, mobile device, or other) to present the data in a wide variety of ways. In embodiments, a GUI of an analytics dashboard is generated that shows the number of profiles in each cohort, as well as the number of profiles who have transitioned from one cohort to another across a date frame chosen by the user (e.g., the number of profiles transitioned from “Champion” to “Needs Attention” in the past 30 days).

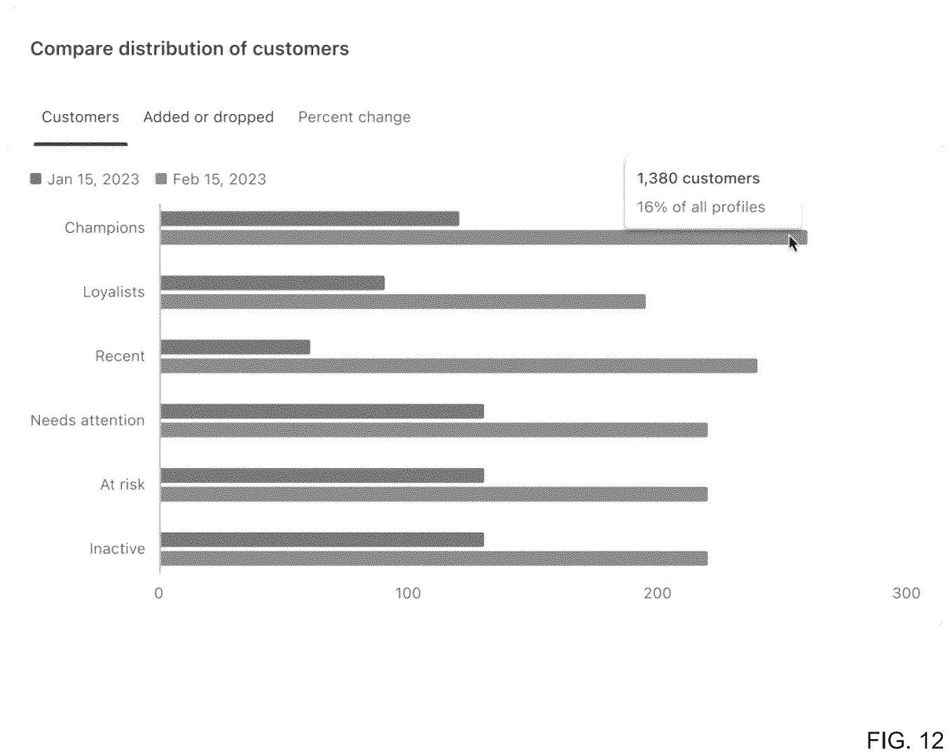

For embodiments, and with reference to FIG. 12, a bar chart is illustrated to show RFM cohort groups by date. On the left side is the RFM cohort group with a blue bar representing the start date and a green bar representing the end date of the report's time range. This chart shows how sub-user groups are changing across a certain period. This report module is operable to indicate the total number of customers and percentile in a group when hovering the cursor over the bar as shown in FIG. 12 where the cursor is hovering over the ‘champions’ 2^{nd} bar (1380 customers, 16% of all profiles).

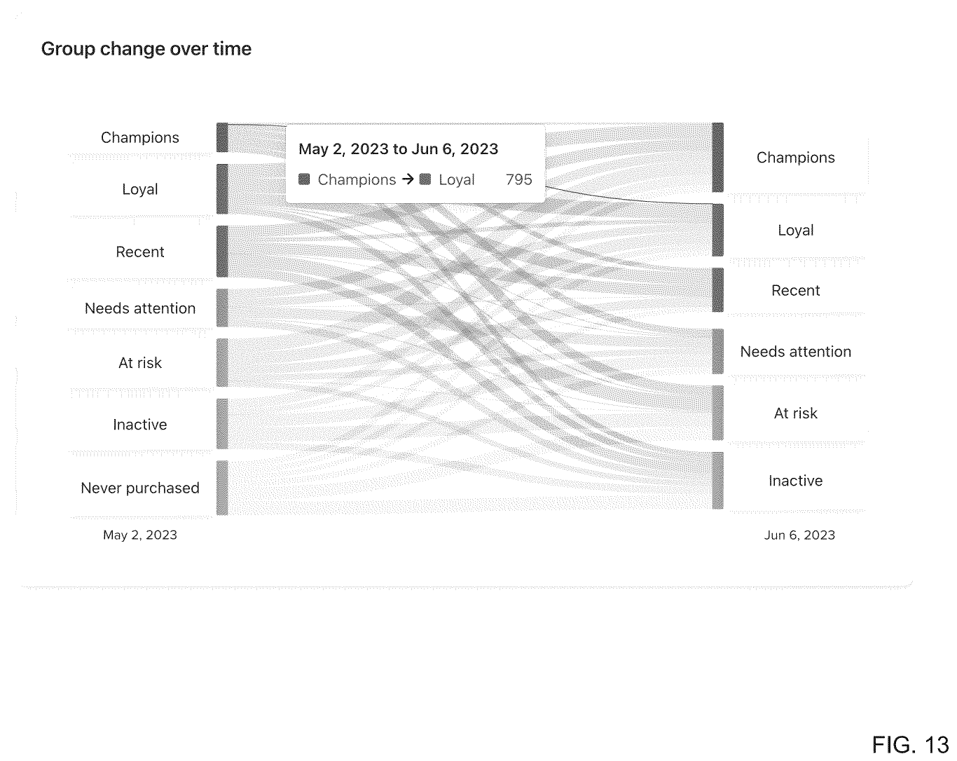

For embodiments, and with reference to FIG. 13, a spaghetti chart is illustrated to show RFM cohort groups change over time. The group change over time card provides a visual representation of the sub-user groups and the potential movements of sub-users between these groups from the selected start to end dates.

The left side of the card is all sub-user groups at the report's start date.

The right side of the card is all sub-user groups at the report's end date.

The lines in between these dates visualize sub-user' movements, and whether they stay in the same group, or move to a different one due to their purchasing behavior. This card is useful in deciphering if there are patterns across these group paths, especially where sub-users may be dropping off in their purchases over time. For example, if many of the ‘Loyal’ sub-users have been primarily moving down to lower groupings and not up to Champions, this may signal a need to re-engage these profiles before they possibly chum (namely, become inactive).

In the embodiment illustrated by FIG. 13, a UI and server are configured and operable to create a pop-out window when the user's cursor is hovered over a sub-user group. The content displayed in the pop-out window is specific for the selected sub-user band which in this example shows 795 sub-users changing from the champion cohort to the loyal cohort between May 2, 2023 and Jun. 6, 2023.

Step 740 states to confirm the RFM cohorts. This step can be performed by the user (namely, the merchant) accepting or confirming the RFM cohort assignments. This step may be performed by the user via their computing device 812 and the API 822. If the user confirms the RFM cohorts, the method proceeds to step 750.

Step 750 states to send cohort assignments to segmentation service, and store the RFM cohort as sub-user/profile property or data point as described above with reference to FIG. 3, and the corresponding text.

However, if the RFM cohorts are not acceptable or desired to the user, the method proceeds to step 760. Step 760 states to modify rules for assigning scaled scores to profile (or raw score) data.

In embodiments, the server 820 is programmed and operable to present and allow a user to adjust what scaled score is assigned to a raw score. In embodiments, an API 822 is programmed to receive the user instructions and manage the data flow for this step. For example, and with reference to FIGS. 14, 15, respectively, the user can choose to define thresholds in terms of raw numbers/values of purchases, or can define the percentile thresholds to define the Frequency scaled scores. In embodiments, similar logic rules are applied for recency and monetary value. Although, in a preferred embodiment, the user is prohibited from being able to adjust recency based on percentile.

Additionally, in embodiments, the user is prohibited from being able to adjust the mapping matrix or transformation.

Additionally, or in the alternative, in some embodiments, the server 820 is programmed and operable to allow the user or operator to modify the predefined mapping matrix.

After the modifications have been entered the process is repeated. In particular, the process returns to step 724 to translate the raw scores based on the modified logic rules into scaled scores or a vector. The mapping step then converts each vector to a type of cohort according to the mapping matrix.

The updated RFM cohorts can be presented or displayed to show RFM cohort changes over time as shown in FIG. 13, for example. This loop is repeated until the updated RFM cohorts are confirmed by the user in which case the method proceeds to step 750. The cohort assignments are then stored to their sub-users as a profile property or datapoint.

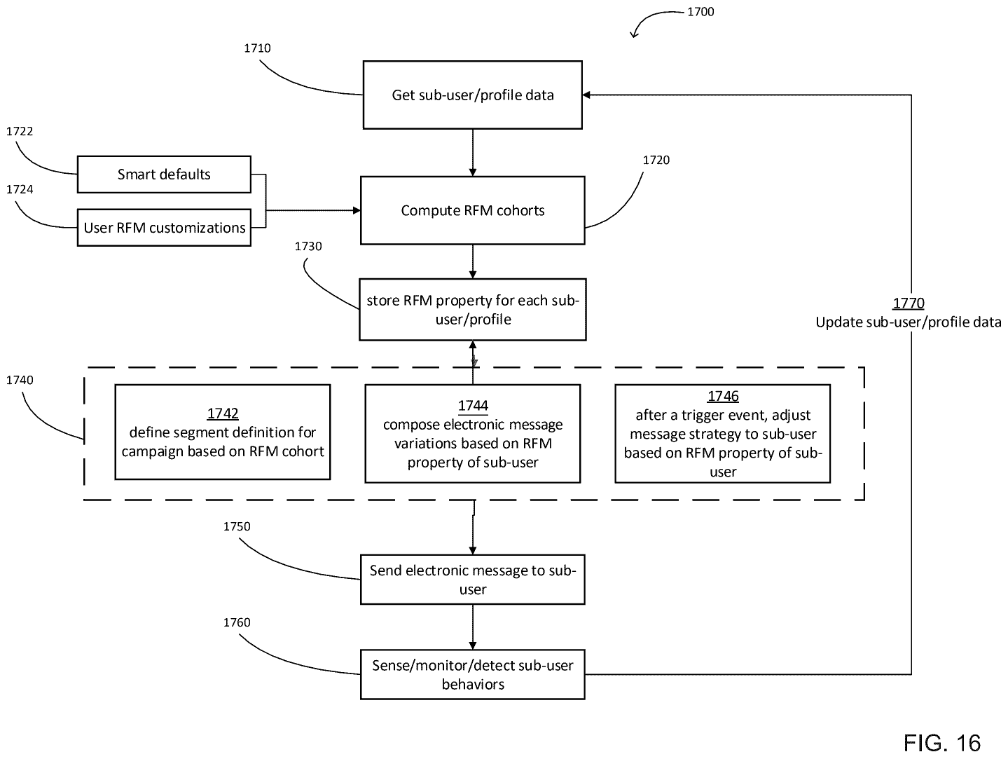

FIG. 16 is a flow chart that includes steps of a method 1700 for sending electronic messages based on RFM properties, according to an embodiment of the invention.

A first step 1710 states to get sub-user/profile data. This step can be performed as described above in connection with FIG. 7 to obtain the data corresponding to the sub-users/profiles.

Step 1720 states to compute the RFM cohorts. This step can be performed as described above in connection with FIG. 7 where smart defaults are initially automatically applied to transform the raw values to a vector for each sub-user. In embodiments, the RFM server is further programmed and operable to accept the user RFM customizations including, without limitation, customization for transforming the raw values for RFM to the scaled values or vectors.

Step 1730 states to store RFM property for each sub-user/profile. As described herein, storing the RFM property as datapoint or profile property for each sub-user adds tremendous value and flexibility in a number of electronic messaging delivery rules 1740 including, e.g., to define segment definition for a campaign based on a RFM cohort 1742; to compose an electronic message variation based on a RFM property of sub-user 1744; and after a trigger event, to adjust a message strategy to a sub-user based on the RFM property of sub-user 1746.

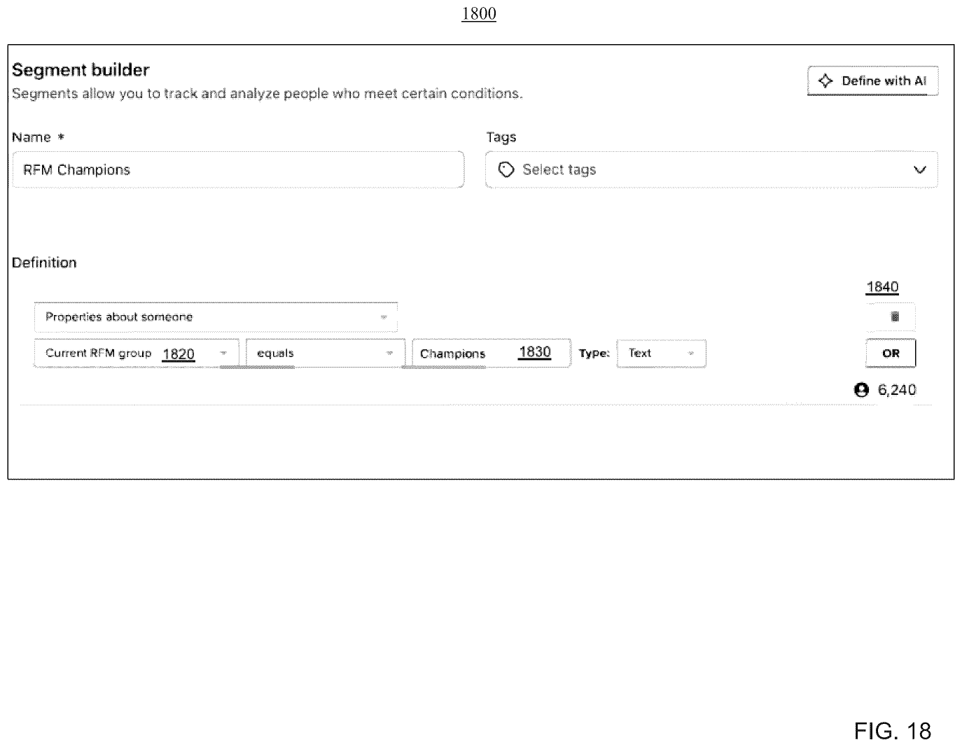

With reference to step 1742, it states to define a segment definition for a campaign based on an RFM cohort. In embodiments, a GUI 1800 is presented to the user as shown in FIG. 18. As shown, a drop-down menu 1820 is displayed in which the user can select ‘current RFM group’ as the field definition, and then choose which type of RFM cohort 1830 (e.g., ‘champions’) to apply for the field. Accordingly, a group of sub-users can be identified based on their RFM cohort property. This logic rule can be combined with other sub-user properties (datapoints) in a wide range of operations including Boolean operations 1840.

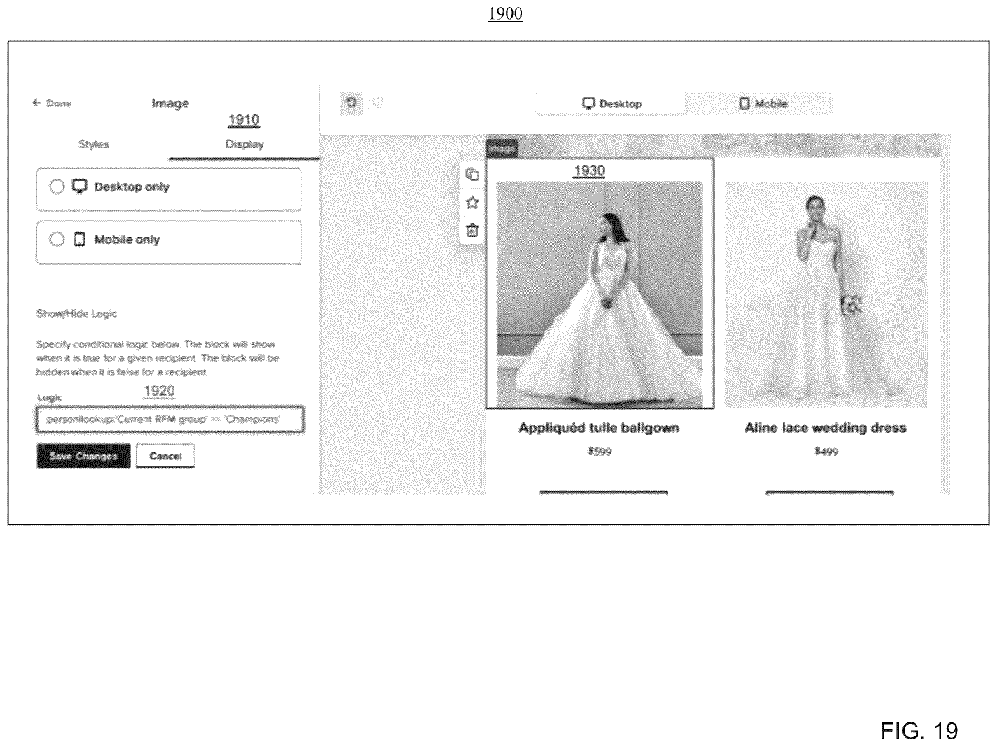

With reference to step 1744, it states to compose an electronic message variation based on a RFM property of sub-user. In embodiments, a GUI is presented to the user as shown in FIG. 19. A window 1910 on the left includes fields for channels of electronic messaging including desktop only and mobile only. The left window also includes a field 1920 for adding a logic setting/rule to show or hide a selected image 1930 (e.g., the ballgown). This setting can be populated by a RFM cohort now that RFM cohort properties have been generated and applied to all the sub-user profiles. Accordingly, in this exemplary embodiment, only the champions cohort would be shown the ballgown image. This could be an important automatic customization in order to provide a certain group specific content and in this example, to provide the champions a potentially higher quality item.

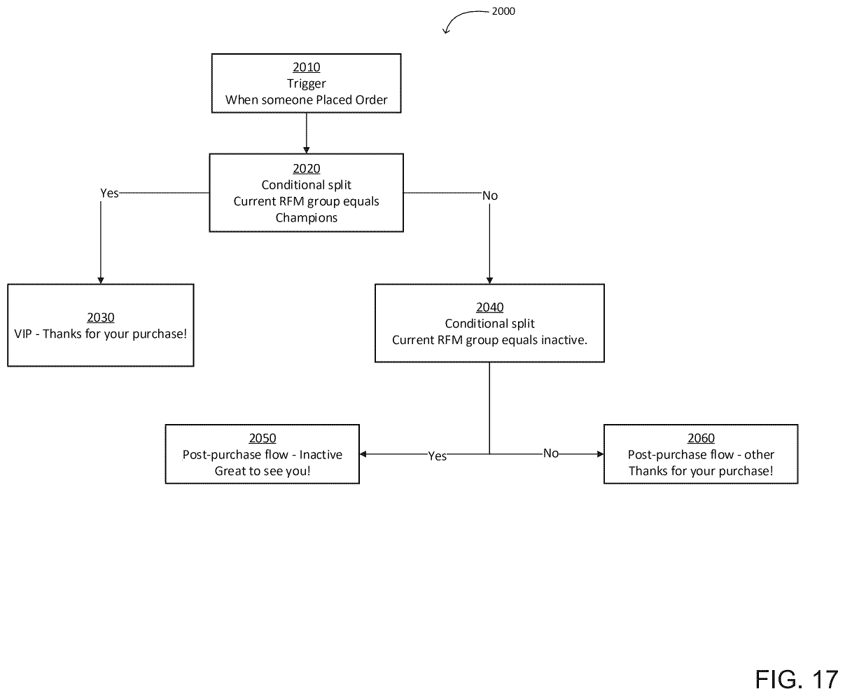

Step 1746 states to, after a trigger event, adjust a message strategy to a sub-user based on the RFM property of the sub-user. In embodiments, and with reference to the flow chart shown in FIG. 17, a method 2000 for preparing and sending an electronic message responsive to a trigger event and based on an RFM property of the sub-user is illustrated, according to embodiments of the invention.

Step 2010 states ‘trigger’ when someone places an order. This step is performed by detecting the action by the sub-user, namely, the placed order typically carried out by the sub-user on a mobile device or computer. A server and database are configured to monitor each sub-user for a particular event identified by the user, and in the example illustrated in FIG. 17, when the sub-user places an order. This event is assigned to an ID number (sometimes referred to as a flow id) and subsequent events and behaviors downstream of this trigger are also assigned to this flow id.

Step 2020 states conditional split, and in particular, current RFM group equals champions. This step is performed by a server being operable to accept the user conditional instruction to set the current RFM to a particular cohort group. Because, as described above, each sub-user profile includes a RFM property or datapoint, a conditional split based on the new RFM property is possible.

If the sub-user profile triggering the event in step 2010 falls in the filtered group identified in step 2020, namely, champions, the process proceeds to step 2030 for automatically preparing an electronic correspondence based on the type of RFM group. Here, in step 2030 under the circumstances described, content is automatically generated. Automatically generated content can be supplied to include content attractive to the RFM group. For example, the sub-user may be identified as a VIP, and thanked for their purchase.

On the other hand, if the sub-user profile triggering the event in step 2010 does not fall in the filtered group identified in step 2020, e.g., champions, the method proceeds to step 2040. Step 2040 applies an additional logic query for whether the current RFM (of a sub-user) equals ‘inactive’. If the sub-user RFM property is ‘inactive’, step 2050 provides automatic content for an electronic message to be sent to the sub-user. For example, a message may be generated such as “Great to see you!”

If the sub-user RFM property is not ‘inactive’, step 2060 can still provide suggested automatic content for an electronic message to be sent to the sub-user. For example, the sub-user may be thanked for their purchase.

Accordingly, in embodiments of invention, after a detected trigger event, methods and systems are operable to automatically prepare electronic messaging content and sending strategies based on the computed user profile properties described herein, and in preferred embodiments, the computed RFM profile properties. In embodiments, the trigger logic is stored on an action service platform such as a flow service platform including one or more dedicated servers and databases.

Now, with reference again to FIG. 16, step 1750 states to send electronic message to sub-user. This step can be performed by the backend or internal server (or another messaging service) to send the electronic messages according to the output from step 1740 all of which is based on the automatically computed, optionally user modified, RFM property for each sub-user.

Step 1760 states to sense, monitor or detect sub-user behaviors. For an embodiment, changes in the entity data are sensed. Examples of entity data that are sensed include placed orders.

Step 1770 states to update sub-user/profile data. The various servers and databases described herein are operable to receive and store the sensed sub-user data (e.g., placed order, a double click to place an order, scroll time over a particular advertisement, geographic location, etc.) and to update various profile data including, e.g., value of purchases, time of new purchases, etc.

In embodiments, step 1770 is performed periodically and, in some embodiments, every 24 hours.

The updated data is then fetched by the RFM server (step 1710), and the entire process 1700 can be repeated. An advantage of embodiments of the invention is the computed profile properties evolve with time based on the continuously monitored sub-user behaviors.

### Action Center

In embodiments, an action center engine is operable to carry out automations based on the assigned RFM cohort or a change in cohort for a sub-user. In embodiments, for each sub-user or entity, the previously computed RFM cohort(s) is also stored as a datapoint or profile property. For embodiments, if a sub-user was a first type of RFM cohort (e.g., a ‘champion’) and is now a second type of RFM cohort (e.g., a ‘Loyalist’), both the previous and instant RFM data points are stored for each sub-user profile.

In embodiments, the action center comprises a set of default logic rules or suggestions, and optionally operable with a UI allowing users to create logic rules to apply RFM cohort transition information such as “send an electronic message to all sub-users who used to be Champions and are now Loyalists”. RFM cohort transitions can be evaluated for a predetermined or user-selected time period. Exemplary time periods include, without limitation, 1 day, 1 week, 1 month, and 1 year or any time period in between (e.g., biweekly or quarterly, etc.).

Whereas old technology may have computed various sub-user or entity profile properties, such techniques lacked the transformation logic, vector mapping, transition information, and automations described herein. Embodiments of the subject invention improve electronic message response times (e.g., speed) and content (e.g., accuracy, relevancy) to sub-users that need attention.

In embodiments, an advantage and improvement to the technical field of database management arises from bifurcating the logic between a translation model or engine and a mapping matrix in the database. By separating the translation model into a processing module, the vector calculation or scoring is performed by a processor executing the logic rules to compute the multi-dimensional vector for the raw scores for each of the recency, frequency, and monetary value. The logic rules initially have default settings but can be adjusted by the user as described herein.

In embodiments, a separate database stores the mapping matrix operable to map the multi-dimensional vector comprising translated scores to a RFM cohort for each sub-user. In embodiments, the matrix is a table comprising rows where each row associates a cohort with a unique combination of multiple translated scores. The use of a database to map the vector to a cohort makes the method fast and flexible. It is fast because the translation step is performed separately from (and differently than) the mapping step. The inventors recognize that organizing the functions into a translation step during a first phase, and a mapping phase during a second phase optimizes the speed and flexibility because (a) the programmed translation engine is best for running an algorithm on the raw scores where the user may desire changes and modification to affect ranking and fine tuning; and (b) the database and tables are more well suited for selecting a cohort based on the multidimensional vector. In embodiments, the RFM database solely performs a mapping operation and looks up the cohort value by matching the subject vector to a vector in a row in the table. The method is flexible because the user can execute, preview, and modify the translated scores by adjusting the parameters to the translation model without impacting the predefined mapping matrix stored in the database.

An advantage and improvement to computing efficiency and/or speed is

An advantage and improvement in accuracy in electronic messaging is

Accuracy of computing sub-user profile properties is improved by the subject invention because of the use of the transformation model and mapping database. The transformation model and mapping matrix is implemented with default settings, some of which can adjusted by the user. Setting and results can be pre-viewed, modified, and repeated until the user is satisfied the RFM is accurate. This is important for creating automations which are actuated on the RFM or a change in the RFM for a sub-user. In contrast, automations based on inaccurate RFM information would be ineffective and wasteful of computing resources.

Although specific embodiments have been described and illustrated, the embodiments are not to be limited to the specific forms or arrangements of parts so described and illustrated. The described embodiments are to only be limited by the claims.

What is claimed:

1. A computer-implemented method for computing and storing an entity profile property to an entity profile database for multiple entities, the method comprises the steps of:
creating and storing transformation logic on an RFM server including a transformation model for transforming a raw score for each entity for each of a recency, frequency, and monetary value to a vector;
creating and storing a mapping matrix on a database on the RFM server for mapping each vector to one of a plurality of types of RFM cohorts;
receiving, by the RFM server, profile data of the multiple entities;
computing, by the RFM server, a raw score for each of recency, frequency, and monetary value for each of the entities;
transforming, by the RFM server, the raw scores to a vector for each entity based on the transformation model;
mapping, by the RFM server, each vector to one of a plurality of types RFM cohorts based on the mapping matrix stored in the database of the RFM server; and
storing, to the entity profile database, the type of RFM cohort as a data point or property for each of the entities.

2. The method of claim 1, further comprising, prior to the storing step, previewing the RFM cohorts as candidate RFM cohorts to a user.

3. The method of claim 2, further comprising, after the previewing step but prior to the storing step:
accepting adjustments to the transformation model from the user;
recomputing the vectors for each of the entities;
re-mapping the vectors to the RFM cohorts for each of the entities; and
re-previewing the RFM cohorts as candidate RFM cohorts to the user, and repeating sequentially the accepting, recomputing, re-mapping and re-previewing steps until the user accepts the candidate RFM cohorts which are then stored as confirmed RFM cohorts, and assigned to each entity as a data point or profile property.

4. The method of claim 1, further comprising generating a new or first list of entities from a database of stored profile data for multiple entities based on filtering the entity data by a first RFM cohort.

5. The method of claim 4, further comprising sending an electronic message to each of the entities in the first list corresponding to the first RFM cohort.

6. The method of claim 1, further comprising generating an electronic message and modifying the content of the message or another property of the electronic message based on the type of RFM property of the entities.

7. The method of claim 6, further comprising sending an electronic message comprising the modifications to each of the entities.

8. The method of claim 1, further comprising:
monitoring entity behavior or activity for a trigger event, evaluating the computed RFM data point of the entity responsible for the triggering event, and
providing a type of candidate electronic action for the user to perform based on the RFM data point of the entity responsible for the trigger event.

9. The method of claim 1, further comprising updating the type of RFM cohort for each entity as entity data changes.

10. The method of claim 9, wherein the updating is performed by sensing changes in the entity data.

11. A system for computing and storing a profile property to an entity profile database for multiple entities comprising:
an entity profile database for collecting and storing profile data for multiple entities;
an RFM server platform comprising:
a raw score module for computing a raw score for each of recency, frequency, and monetary value for each of the entities based on the profile data of the entities;
a transformation engine comprising logic for transforming the computed recency, frequency and monetary raw scores to a single multi-dimensional vector for each entity;
a mapping database for creating and storing data tables comprising a mapping matrix for mapping the vector to an RFM cohort; and
a main module for receiving the entity data from the entity profile database, communicating with the transformation engine and mapping database, and storing the type of RFM cohort as a data point or property for each of the entities to the entity profile database.

12. The system of claim 11, wherein the server is further configured to, prior to the storing step, preview the RFM cohorts as candidate RFM cohorts to the user.

13. The system of claim 12, wherein the server is further configured to, after the previewing step but prior to the storing step:
accept adjustments to the transformation model from the user;
recompute the vectors for each of the entities;
re-map the vectors to the RFM cohorts for each of the entities;
re-preview the RFM cohorts as candidate RFM cohorts to the user; and
repeat sequentially the accepting, recomputing, re-mapping and re-previewing steps until the user accepts the candidate RFM cohorts which are then stored as confirmed RFM cohorts, and assigned to each sub-user/entity as a data point or profile property.

14. The system of claim 11, wherein the server is further configured to generate a first list of entity profiles from a database of stored entity data based on filtering the entity data by a first RFM cohort.

15. The system of claim 14, wherein the server is further configured to send an electronic message to each of the entities in the first list corresponding to the first RFM cohort.

16. The system of claim 11, wherein the server is further configured to generate an electronic message and modifying the content of the message or another property of the electronic message based on the type of RFM property of the entities.

17. The system of claim 16, wherein the server is further configured to send an electronic message, as modified, to each of the entities.

18. The system of claim 11, wherein the server is further configured to:
monitor entity behavior or activity for a trigger event;
evaluate the computed RFM data point of the entity responsible for the triggering event, and
provide a type of candidate electronic action for the user to perform based on the RFM data point of the entity responsible for the trigger event.

19. The system of claim 11, wherein the server is further configured to update the type of RFM cohort for each entity as entity data changes.

20. The system of claim 19, wherein the server is further configured to update overall segments as entity data changes by sensing changes in the entity data, namely, placed orders.
